(19) United States
(12) Patent Application Publication
(10) Pub. No.: US 2007/0171979 A1
(43) Pub. Date: Jul. 26, 2007

(54) Method of video decoding

(76) Inventors: Onno Eerenberg, Eindhoven (NL); Johannes Yzebrand Tichelaar, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/590,249

(22) PCT Filed: Feb. 9, 2005
(86) PCT No.: PCT/IB05/50506

§ 371 Date: Aug. 17, 2006

(30) Foreign Application Priority Data
Feb. 20, 2004 (EP) 04100683.4

(51) Int. Cl. H04N 11/04

(52) U.S. Cl. 375/240.24

(57) ABSTRACT

A method of decoding video data (ENC(VI)) in a video decoder (50) for regenerating sequence of images (VO) is described. The method involves arranging for the decoder (50) to include processing means (70) coupled to data memory (60). Moreover, the method involves: (a) receiving and then storing the video data (ENC(VI)) including anchor picture data; (b) processing the video data to generate luminance and chrominance block data; (c) processing the luminance and chrominance data to generate corresponding macroblock data (130); and (d) applying motion compensation to generate from the macroblock data (130) and one or more anchor pictures the sequence of decoded images (VO). The method applies the compensation such that the motion vectors derived from the macroblocks (130) used for reconstructing the sequence of images (VO) are analyzed and macroblocks accordingly sorted to provide for more efficient transfer of one or more video areas from one or more anchor pictures between the memory (60) and the processing means (70).

### FIELD OF THE INVENTION

The present invention relates to methods of video decoding; in particular, but not exclusively, the invention relates to a method of video decoding for decoding images which have been encoding pursuant to contemporary standards such as MPEG. Moreover, the invention also relates to apparatus arranged to implement the method of decoding.

### BACKGROUND TO THE INVENTION

Efficient organization of data memory in image processing apparatus is known. Such apparatus is operable to handle sequences of images, each image being represented by data which are often of considerable size. The sequences of images are often compressed in encoded form so that their corresponding data is not inconveniently large for storage on data carriers, for example on optically readable optical memory discs such as DVD's. However, the use of decoding requires that encoded data is stored and processed to generate corresponding decoded image data which is frequently of considerable size, for example several MBytes of data per image. The temporary storage and processing of such image data is an important aspect of the operation of such apparatus.

In a published international PCT application no. PCT/IB02/00044 (WO 02/056600), there is described a memory device susceptible to being operated in a burst access mode to access several data words of the device in response to issuing one read or write command to the device. The access mode involves communicating bursts of data representing non-overlapping data-units in the memory device, the device being accessible only as a whole on account of its logic design architecture. On account of a request for data often including only a few bytes and the request being arranged to be able to overlay more than one data-unit of the device, the device is potentially subject to significant transfer overhead. In order to reduce this overhead, an efficient mapping from logical memory addresses to physical memory addresses of the device is employed in the device. The efficient mapping requires that the device comprises a logic array partitioned into a set of rectangles known as windows, wherein each window is stored in a row of the memory device. Requests for data blocks that are stored or received are analyzed during a predetermined period to calculate an optimal window size, such analysis being performed in a memory address translation unit of the device. The translation unit is operable to generate an appropriate memory mapping. The memory device is susceptible to being used in image processing apparatus, for example as in MPEG image decoding.

The inventor has appreciated that it is highly desirable to decrease memory bandwidth required in image decoding apparatus, for example in video decoding apparatus. Reduction of such bandwidth is capable of reducing power dissipation in, for example, portable video display equipment such as palm-held miniature viewing apparatus as well as apparatus of more conventional size. In order to decrease such memory bandwidth, the inventor has devised a method of video decoding; moreover, apparatus functioning according to the method has also been envisaged by the inventor.

### SUMMARY OF THE INVENTION

A first object of the present invention is to provide a method of decoding video image data in an apparatus including at least one main memory and cache memory coupled to processing facilities for more efficiently utilizing data bandwidth to and/or from the at least one main memory.

According to a first aspect of the present invention, there is provided a method of decoding video data in a video decoder to regenerate a corresponding sequence of images, characterized in that the method includes the steps of:
(a) arranging for the decoder to include processing means coupled to an associated main data memory and a data cache memory;
(b) receiving the video data including anchor picture data in compressed form at the decoder and storing the data in the main memory;
(c) processing the compressed video data in the processing means to generate corresponding macroblock data including motion vectors describing motional differences between the images in the sequence; and
(d) applying motion compensation in the processing means to generate from the macroblock data and one or more anchor pictures the corresponding sequence of decoded images;
   the method being arranged to apply the motion compensation such that the motion vectors derived from the macroblocks used for reconstructing the sequence of images are analyzed and macroblocks accordingly sorted so as to provide for more efficient data transfer between the main memory and the processing means.

The invention is of advantage in that it is capable of more efficiently utilizing data bandwidth of the main memory.

In order to further elucidate the present invention, some background will now be provided. The concept of the present invention is to map as many macroblocks, determined by a sorting process, as possible onto a certain video area in a unified memory. This area is then subsequently retrieved from the memory resulting in an efficient usage of associated memory bandwidth. A situation can potentially arise that there is only one macroblock that can be reconstructed with such retrieved data. A number of macroblocks that can be decoded depends, amongst other factors, on a total area size that can be retrieved and characteristics of their predictively encoded picture. This area size is determined, for example, by the size of an embedded memory of an MPEG decoder. The area size that can be retrieved is not always constant and depends on a sorting process employed. For a situation that a retrieved size is only one macroblock, there is potentially no efficiency gain provided by the present invention.

Preferably, in the decoding method, the sequence of images includes at least one initial reference image from which subsequent images are generated by way of applying motion compensation using the motion vectors.

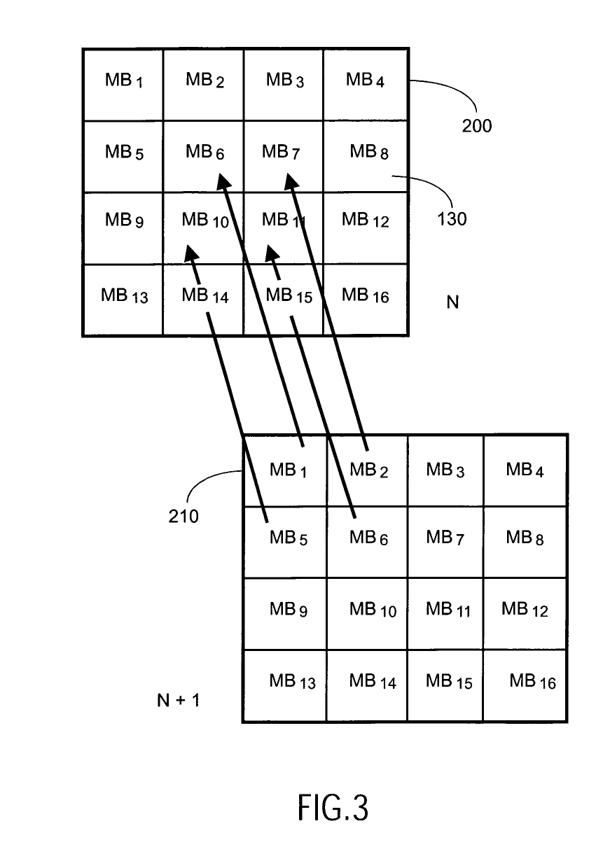

Preferably, in the decoding method, groups of macroblocks transferred between the processing means and the memory correspond to spatially neighboring macroblocks in one or more of the images. By way of background, although FIG. 3 illustrates a situation where there are four adjacent macroblocks, this will in practical reality often not be the case. A typical situation will be that several macroblocks can be reconstructed using a bounded area from an original anchor picture. The shape thereby generated can be rectangular, square or even triangular. An advanced implementation of the invention searches for an optimum shape for minimizing data transfer rates.

Preferably, in the decoding method, one or more of the images are represented in one or more corresponding video object planes in the memory, said one or more planes including data relating to at least one of coding contour information, motion information and textural information.

Preferably, in the decoding method, the video object planes are arranged to include one or more video objects which are mapped by said motion compensation in the processing means from one or more earlier images to one or more later images in the sequence.

Preferably, in the decoding method, the step (a) is arranged to receive video data read from a data carrier, preferably an optically readable and/or writable data carrier, and/or a data communication network.

Preferably, the decoding method is arranged to be compatible with one or more block-based video compression schemes, for example MPEG standards.

According to a second aspect of the present invention, there is provided a video decoder for decoding video data to regenerate a corresponding sequence of images, characterized in that the decoder includes:
(a) receiving means for acquiring the video data including anchor picture data in compressed form at the decoder and storing the data in a main memory;
(b) processing means for:
(i) processing the compressed video data to generate corresponding macroblock data including motion vectors describing motional differences between the images in the sequence; and
(ii) applying motion compensation using the motion vectors to generate from the macroblock data and one or more anchor pictures the corresponding sequence of decoded images;
   the decoder being operable to apply the motion compensation such that the motion vectors derived from the macroblocks used for reconstructing the sequence of images are analyzed and macroblocks accordingly sorted so as to provide for more efficient data transfer between the main memory and the processing means.

Preferably, the decoder is arranged to process the sequence of images including at least one initial reference image from which subsequent images are generated by way of applying motion compensation using the motion vectors.

Preferably, the decoder is arranged in operation to transfer groups of macroblocks between the processing means and the memory, the groups corresponding to spatially neighboring macroblocks in one or more of the images.

Preferably, in the decoder, one or more of the images are represented in one or more corresponding video object planes in the memory, said one or more planes including data relating to at least one of coding contour information, motion information and textural information. More preferably, the decoder is arranged to process the video object planes arranged to include one or more video objects which are mapped by said motion compensation from earlier images to later images in the sequence.

Preferably, in the decoder, the receiving means is arranged to read the video data from at least one of a data carrier, for example a readable and/or writable optical data carrier, and a data communication network.

Preferably, the decoder is arranged to be compatible with one or more block-based compression schemes, for example MPEG standards.

It will be appreciated that features of the invention are susceptible to being combined in any combination without departing from the scope of the invention as defined by the accompanying claims.

### DESCRIPTION OF THE DIAGRAMS

Embodiments of the invention will now be described, by way of example only, with reference to the following diagrams wherein:

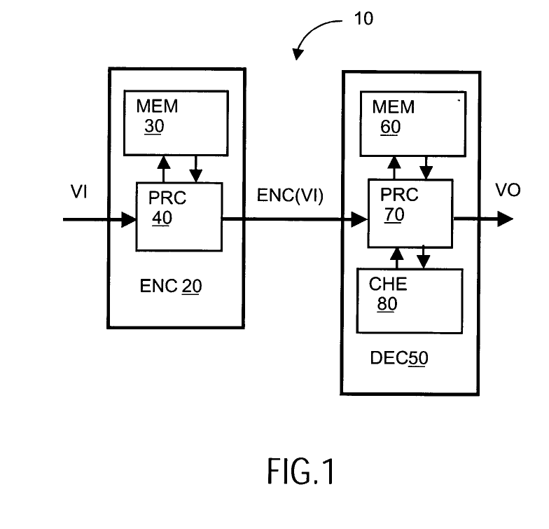

FIG. 1 is a schematic diagram of a system comprising an encoder and a decoder, the decoder being operable to decode video images according to the invention;

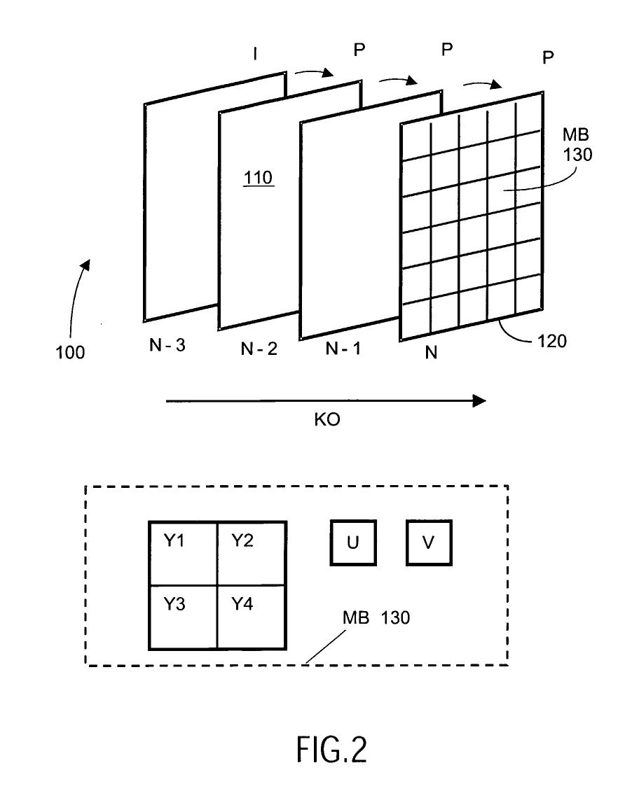

FIG. 2 is an illustration of the generation of video object planes as utilized in contemporary MPEG encoding methods;

FIG. 3 is a schematic illustration of a method of reorganizing image-representative macroblocks in memory according to a method of the invention; and

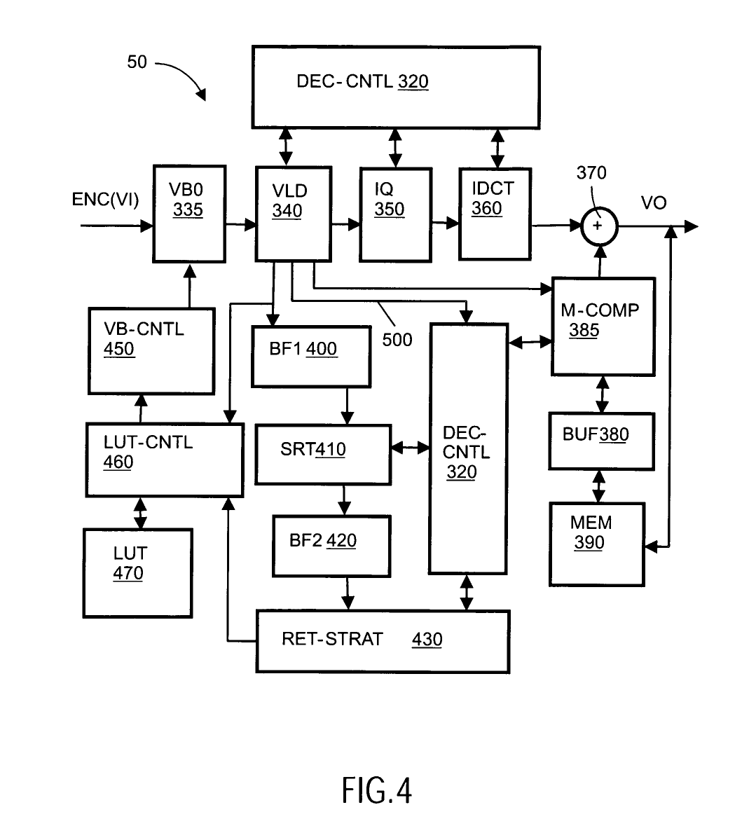

FIG. 4 is a practical embodiment of the decoder of FIG. 1.

### DESCRIPTION OF EMBODIMENTS OF THE INVENTION

Contemporary video decoders, for example video decoders configured to decode images encoded pursuant to contemporary MPEG standards, for example MPEG-4, are operable to decode compressed video data based on the order in which encoded images are received. Such an approach is generally desirable to reduce memory storage requirements and enable a relatively simpler design of decoder to be employed. Moreover, contemporary video decoders often use unified memory, for example static dynamic random access memory (SDRAM) in conjunction with a memory arbiter. Conventionally, reconstruction of predictive images is based on manipulation of macroblocks of data. When processing such macroblocks, it is customary to retrieve image regions from memory corresponding to n n×n pixels where n is a positive integer.

The inventor has appreciated that such retrieval of image regions is an inefficient process because, due to data handling in the memory, more data is frequently read from memory than actually required for image decoding purposes.

The present invention seeks to address such inefficiency by changing an order in which macroblocks are retrieved from memory to increase an efficiency of data retrieval and thereby decrease memory bandwidth performance necessary for, for example, achieving real-time image decoding from MPEG encoded input data. In the solution devised by the inventor, macroblocks of each predictively coded image to be decoded are sorted such that a data block read from the memory includes one or more macroblocks of an anchor picture whose macroblocks can be decoded without reading further data from memory. Moreover, the inventor has appreciated that such sorting is preferably performed on the basis of a motion vector analysis.

In order to further describe the invention, a brief description of MPEG encoding will now be provided.

MPEG, namely “Moving Picture Experts Group”, relates to international standards for coding audio-visual information in a digital compressed format. The MPEG family of standards includes MPEG-1, MPEG-2 and MPEG-4, formally known as ISO/IEC-11172, ISO/IEC-13818 and ISO/IEC-14496 respectively.

In the MPEG-4 standard, MPEG encoders are operable to map image sequences onto corresponding video object planes (VOPs) which are then encoded to provide corresponding output MPEG encoded video data. Each VOP specifies particular image sequence content and is coded into a separate VOL-layer, for example by coding contour, motion and textural information. Decoding of all VOP-layers in an MPEG decoder results in reconstructing an original corresponding image sequence.

In an MPEG encoder, image input data to be encoded can, for example, be a VOP image region of arbitrary shape; moreover, the shape of the region and its location can vary from image frame to image frame. Successive VOP's belonging to a same physical object appearing in the image frames are referred to as Video Objects (VO's). The shape, motion and texture information of VOP's belonging to the same VO is encoded and transmitted or coded into a separate VOP. In addition, relevant information needed to identify each of the VOL's and a manner in which various VOL's are composed at an MPEG decoder to reconstruct the entire original sequence of image frames is also included in an encoded data bitstream generated by the MPEG encoder.

In MPEG encoding, information relating to shape, motion and texture for each VOP is coded into a separate VOL-layer in order to support subsequent decoding of VO's. More particularly, in MPEG-4 video encoding, there is employed an identical algorithm to code for shape, motion and texture information in each of the VOL-layers.

The MPEG-4 standard employs a compression algorithm for coding each VOP image sequence, the compression algorithm being based on a block-based DPCM/Transform coding technique as employed in MPEG-1 and MPEG-2 coding standards. In the MPEG-4 standard, there is encoded a first VOP in an intra-frame VOP coding mode (I-VOP). Each subsequent frame thereto is coded using inter-frame VOP prediction (P-VOP's) wherein only data from a nearest previously coded VOP frame is used for prediction. In addition, coding of B-directionally predicted VOP's (B-VOP's) is also supported as will be elucidated in greater detail later.

Referring firstly to FIG. 1, there is shown an encoder-decoder system indicated generally by 10. The system 10 comprises an encoder (ENC) 20 including a data processor (PRC) 40 coupled to an associated video-buffer (MEM) 30. Moreover, the system 10 also comprises a decoder (DEC) 50 including a data processor (PRC) 70 coupled to an associated main video buffer memory 60 and also to a fast cache memory 80.

A signal corresponding to an input sequence of video images VI to be encoded is coupled to the processor 40. An encoded video data ENC(VI) corresponding to an encoded version of the input signal VI generated by the encoder 20 is coupled to an input of the processor 70 of the decoder 50. Moreover, the processor 70 of the decoder 50 also comprises an output VO at which a decoded version of the encoded video data ENC(VI) is output in operation.

Referring now to FIG. 2, there is shown a series of video object planes (VOP's) commencing with an I-picture VOP (I-VOP) and subsequent P-picture VOP's (P-VOP's) in a video sequence following a coding order denoted by KO, the series being indicated generally by 100 and an example frame being denoted by 110; the series 100 corresponds to the signal VI in FIG. 1. Both the I-pictures and P-pictures are capable of functioning as anchor pictures. In the contemporary MPEG standard described earlier, each P-VOP is encoded using motion compensated prediction based on a nearest previous P-VOP frame thereto. Each frame, for example the frame 120, is sub-divided into macroblocks, for example a macroblock denoted by 130. When each macroblock 130 in the frames 120 is encoded, information relating to the macroblock's data pertaining to luminance and co-sited chrominance bands, namely four luminance blocks denoted Y1, Y2, Y3, Y4, and two chrominance blocks denoted by U, V, are encoded; each block corresponds to 8×8 pels wherein “pel” is an abbreviation for “pixel elements”.

In the encoder 20, motion estimation and compensation is performed on a block or macroblock basis wherein only one motion vector is estimated between VOP frame N and VOP frame N−1 for a particular block or macroblock to be encoded. A motion compensated prediction error is calculated by subtracting each pel in a block or macroblock belonging to the VOP frame N with its motion shifted counterpart in the previous VOP frame N−1. An 8×8 element discrete cosine transform (DCT) is then applied to each of the 8×8 blocks contained in each block or macroblock followed by quantization of the DCT coefficients with subsequent variable run-length coding and entropy coding (VLC). It is customary to employ a video buffer, for example the video buffer 30, to ensure that a constant target bit rate output is produced by the encoder 20. A quantization step size for the DCT-coefficients is made adjustable for each macroblock in a VOP frame for achieving a preferred bit rate and to avoid buffer overflow and underflow.

In MPEG decoding, the decoder 50 employs an inverse process to that described in the preceding paragraph pertaining to MPEG encoding methods, for example executed within the encoder 20. Thus, the decoder 50 is operable to reproduce a macroblock of a VOP frame M. The decoder 50 includes the main video buffer 60 memory for storing incoming MPEG encoded video data which is subject to a two-stage parsing process, a first parsing stage for analyzing an interrelation between macroblocks decoded from the encoded video data ENC(VI) for determining a macroblock sorting strategy, and a second parsing stage for reading out the macroblocks in a preferred sorted order from the main memory 60 for best utilizing its bandwidth. In the first stage, the variable length words are decoded to generate pixel values from which prediction errors can be reconstructed. When the decoder 50 is in operation, motion compensated pixels from a previous VOP frame M−1 contained in a VOP frame store, namely the video buffer 60, of the decoder 50 are added to the prediction errors to subsequently reconstruct macroblocks of the frame M. It is access to the video buffer 60 of the decoder 50 and/or to the VOP frame store of the decoder 50 which the present invention is especially concerned with and will be elucidated in greater detail later.

In general, input images coded in each VOP layer are of arbitrary shape and the shape and location of the images vary over time with respect to a reference window. For coding shape, motion and textural information in arbitrarily-shaped VOP's, MPEG-4 employs a “VOP image window” together with a “shape-adaptive” macroblock grid. A block-matching procedure is used for standard macroblocks. The prediction code is coded together with the macroblock motion vectors used for prediction.

During decoding in the decoder 50, an anchor picture, namely a picture for example corresponding to the aforementioned IVOP, an amount of pixels retrieved during MPEG decoding corresponds to a corresponding area of a predictive macroblock. The retrieved pixels will depend upon motion vectors associated with a corresponding macroblock in a predictive picture corresponding, for example, to a P-VOP. Thus, the retrieved pixels will depend on the motion vectors associated with the macroblock in the predictive picture. Consequently, video data retrieval, especially small area sizes such as one macroblock limited to a macroblock area, results in inefficient usage of memory bandwidth of the buffer 60 which the invention seeks to address.

In order to elucidate such inefficient memory usage, FIG. 3 will next be described. There is shown an anchor picture indicated by 200 corresponding to an image picture frame N in the sequence of encoded video images VI. Moreover, there is shown a subsequent image frame N+1 indicated by 210 corresponding to a subsequent image picture frame N+1. In each of the picture frames, macroblocks are shown numbered from MB¹ to MB₁₆. As an example, the macroblock MB₁ in the predictive picture 210 (N+1) with aid of the macroblock MB₆ is derivable from the anchor picture 200 (N). It will be appreciated from FIG. 3 that surrounding macroblocks MB₂, MB₅, MB₆ of the predictive picture 210 are compensated with aid of macroblocks MB₇, MB₁₀, MB₁₁ of the anchor picture 200. The inventor has appreciated that, in an MPEG compatible decoder, it is advantageous to employ a method arranged to analyze predictive motion vectors first by accessing macroblocks associated with the picture 210 prior to reconstructing a corresponding image for viewing; such a method enables an MPEG video decoder to fetch a whole video area in a single operation from the video buffers 60, which is more efficient when accessing video buffers implemented in logic memory repetitively for relative smaller quantities of data, thereby utilizing bandwidth of the buffer 60 more effectively. Moreover, a burst length of data from an SDRAM also plays a role in that a non-optimal value of such burst length leads to retrieval of non-requested data and hence inefficient memory bandwidth utilization.

The macroblocks MB of a predictably coded picture to be decoded in the decoder 50 are preferably sorted such that a data block read from a video buffer includes one or more macroblocks MB of an anchor picture, for example from the image frame 100 N, these at least two macroblocks being susceptible to decoding without further reading of data from the aforementioned video buffer 60. Moreover, the one or more macroblocks in the data block are preferably selected or sorted on the basis of a motion vector analysis of changes occurring in a sequence of images as illustrated in FIG. 2. A practical embodiment of the present invention preferably uses variable block sizes depending upon a number of macroblocks that can be successfully reconstructed. There is an upper number which pertains for maximum block size which is dependent on MPEG decoder embedded memory capacity.

A practical embodiment of the decoder 50 will now be described with reference to FIG. 4. The decoder 50 comprises a decoder control unit (DEC-CNTL) 320. The encoded signal ENC(VI) is coupled to an input video buffer (VB0) 335 implemented as a FIFO; such a buffer is capable of functioning in a dual manner of a FIFO and as well as a random access memory for block sorting purposes. A data output of the buffer VB0 335 is connected via a variable length decoding function (VLD) 340 to an inverse quantization function (IQ) 350 and therefrom further to an inverse discrete cosine transform function (IDCT) 360 followed by a summer (+) 370 to provide the aforementioned decoded video output (VO). The variable length decoding function VLD 340, the inverse quantization function IQ 350 and the IDCT function 360 are coupled for control purposes to the control unit DEC-CNTL 320.

The VLD function 340 has a dual operation, namely in a first mode to retrieve high-level layer information such as byte-based headers indicative of slice size, pixels per line, pel size and similar information which is fed to the DEC-CNTL 320, and in a second mode to provide variable length decoding.

The summer 370 is also arranged to receive data from a motion compensator (M-COMP) 385 which is fed data via a data cache 380 from a memory (MEM) 390, corresponding to the memory 60 in FIG. 1, coupled to the output VO. The compensator M-COMP 85 is coupled for control purposes to the control function DEC-CNTL 320 as shown. Moreover, the compensator 385 is also arranged to receive data from the variable length decoding function VLD 340 and arrange for macroblocks to be output in a correct sequence to the summer 370. The decoding function VLD 340 is also arranged to output data via a first buffer (BF1) 400 to a sorting function (SRT) 410 and thereafter to a second buffer (BF2) 420. Output data from the second buffer BF2 420 is passed through a retrieval strategy function (RET-STRAT) 430 which is operable to output strategy data to a look-up table control function (LUT-CNTL) 460 which is coupled to a look-up table unit (LUT) 470. The LUT 470 is dynamically updated to provide a mapping of macroblock address/(number) to corresponding addresses in the memory MEM 390. Output from the LUT control function 460 is coupled to a video buffer control function (VB-CNTL) 450 which in turn is operable to control data flow through the video buffer VB0 335. The control function CNTL 320 is connected to the sorting function 410 for supervising its operation. The decoder 50 is susceptible to being implemented in software executable on one or more computing devices. Alternatively, it can be implemented in hardware, for example as an application specific integrated circuit (ASIC). Additionally, the decoder 50 is also susceptible to being implemented as a mixture of dedicated hardware in combination with computing devices operating under software control.

Operation of the decoder 50 depicted in FIG. 4 will now be described briefly in overview. Retrieval of video data from the buffer VB0 335 is implemented in dual manner, namely in a first mode of macroblock analysis and in a second mode of macroblock sorting for macroblock output in a more memory-efficient sequence.

In the first mode, in order to filter out all Predicted Motion Vectors (PMV's), the buffer VB0 335 is read according to a FIFO read strategy wherein read addresses are available to determine start positions of macroblocks. During video loading, relevant information such as macroblock number, PMV, a number of PMV's being handled, sub-pixel decoding and other related parameters is passed via the first buffer BF1 400 to the sorting function SRT 410. Data received at the sorting function SRT 410 is used in a macroblock retrieval strategy determining how many macroblocks can be decoded simultaneously when a certain area of an anchor picture in the decoded video data ENC(VI) is retrieved, for example in a block read-out manner as elucidated in the foregoing with reference to FIGS. 1 to 3. The LUT control function LUT-CNTL 460 is dynamically updated and is used to determine macroblock start addresses with aid of corresponding macroblock (address)/numbers. When executing PMV extraction, macroblock start addresses are determined and stored in the LUT unit 470. The motion compensator M-COMP 380 is operable to retrieve required reconstruction video information based on information provided by the strategy function 430.

In the decoder 50, MPEG variable length coding (VLC) is accommodated because such encoding is capable of providing data compression. When operating, the decoder 50 starts from high-level layers in the input data ENC(VI), for example to extract MPEG header information, and then progresses down to macroblock layer. The PMV is part of a predictive encoded macroblock and is also variable length encoded. At the MPEG encoder ENC 20, after subtraction of predicted macroblocks obtained by motion estimation and original macroblocks, there is usually a residual error signal corresponding to a difference after subtraction. This residual error signal is encoded and transmitted in the encoded data ENC (VI). Processing steps implemented at the encoder ENC 20 are for transforming groups of 8×8 pixel DCT blocks to the frequency domain. After such transformation to the frequency domain, transform quantization is applied to reduce individual frequency components. The result is then by way of a zig-zag or alternative scan coded converted to run-level code words. At the decoder 50, inverse processing is applied to regenerate the 8×8 pixel DCT block data again. This data macroblock data retrieved from anchor pictures determined by the PMV data is used to generate corresponding one or more final reconstructed macroblocks.

In the decoder 50, received MPEG data is processed by first extracting header data which are stored in the DEC-CNTL 320 as depicted by a link 500 in FIG. 4. Such information is used for controlling and sorting each macroblock individually, and image slices comprising one or more macroblocks. When handling individual macroblocks at a lower level, the following description provides an overview of operation of the decoder 50. Table 1 provides a sequence of macroblock handling commands executed in the decoder 50, the sequence being subsequently described in more detail.

TABLE 1

| macroblock( ) { | No. of bits | Mnemonic |
|---|---|---|
| while (nextbits( )==‘000 0001 000’) | | |
| macroblock_escape | 11 | bslbf |
| macroblock_address_increment | 1-11 | vlebf |
| macroblock_modes( ) | | |
| if (macroblock_quant) | | |
| quantiser_scale_code | 5 | uimsbf |
| if (macroblock_motion_forward\|\| | | |
| (macroblock_intra && | | |
| concealment_motion_vectors)) | | |
| motion_vectors (0) | | |
| if (macroblock_motion_backward) | | |
| motion_vectors (1) | | |
| if (macroblock_intra && | 1 | bslbf |
| concealment_motion_vectors) | | |
| marker_bit | | |
| if (macroblock_pattern) | | |
| coded_block_pattern( ) | | |
| for (i=0; i<block_count; i++) { | | |
| block (i) | | |
| } | | |
| } | | |

In a macroblock_escape sub-routine call, the macroblock_escape is a fixed bit-string ‘000 0001 000’ which is used when a difference between macroblock_address and previous-macroblock_address is greater than 33. It causes the value of macroblock_address_increment to be 33 greater than the value that is decoded by subsequent macroblock-escape and the macroblock_address_increment codewords.

In a macroblock_address_increment sub-routine call, the macroblock_address_increment is a variable length coded integer which is coded for indicating a difference between macroblock_address and previous_macroblock_address. A maximum value for the macroblock_address_increment is 33. Values greater than 33 are encodable using the macroblock-escape codeword. The macroblock_address is a variable defining an absolute position of a current macroblock, such that macroblock_address of a top-macroblock in an image is zero. Moreover, the previous_macroblock_address is a variable defining an absolute position of a last non-skipped macroblock, as described in more detail later, except at the start of an image slice. At the start of a slice, the variable previous_macroblock_address is reset as follows in Equation 1 (Eq. 1):
previous_macroblock_address=(mb_row*mb_width)−1 Eq. 1

Moreover, the horizontal spatial position in macroblock units of a macroblock in an image, namely mb_column, is computable from the macroblock_address from Equation 2 (Eq. 2):
mb_column=macroblock_address % mb_width Eq. 2
where mb_width is a number of macroblocks in one row of a picture encoded in the signal ENC(VI).

Except at the start of a slice, if the value of macroblock_address recovered from the previous_macroblock_address by more than 1, then some macroblocks have been skipped It is therefore a requirement that:
(a) there are no skipped macroblocks in I-pictures except when either picture_spatial_scalable_extensiono follows the picture_header() of a current picture, or sequence_scalable_extension() is present in a bitstream being processed and scalable_mode=‘SNR scalability’;
(b) the fist and last macroblock of a slice are not skipped;
(c) in a B-picture, there are no skipped macroblocks immediately following a macroblock in which macroblock_intra has a value ‘1’.

In decoding the signal ENC(VI), the decoder 50 also utilizes a concept of macroblock modes and is operable to execute an instruction sequence as provided in Table 2 with regard to such modes.

TABLE 2

| | No. of | |
|---|---|---|
| macroblock_modes( ) { | bits | Mnemonic |
| macroblock_type | 1-9 | vlclbf |
| if((spatial_temporal_weight_code_flag=1) && | | |
| (spatial_temporal_weight_code_table_index | | |
| !=‘00’)) { | | |
| spatial_temporal_weight_code | 2 | uimsbf |
| } | | |
| if (macroblock_motion_forward \|\| | | |
| macroblock_motion_backward) { | | |
| if (picture_structure==‘frame’) { | | |
| if (frame_pred_frame_dct==0) | | |
| frame_motion_type | 2 | uisbf |
| } else { | | |
| field_motion_type | | |
| } | | |
| } | | |
| if ((picture_structure==‘Frame picture’) && | | |
| frame_pred_frame_dct==0) && | | |
| (macroblock_intra \|\| macroblock_pattern)) { | | |
| dct_type | 1 | uimsbf |
| } | | |
| } | | |

In the macroblock modes, a sub-routine call macroblock_type relates to a variable length coded indicator for indicating a method of coding and content of a macroblock selected by picture_coding_jype and scalable_mode. For macroblock sorted decoding, only Tables 2 and 3 pertain. Table 2 is concerned with variable length codes for macroblock_type in P-pictures in the signal ENC(VI), whereas Table 3 is concerned with variable length codes for macroblock_type in B-pictures in the signal ENC(VI).

TABLE 3

| C3.1 | C3.2 | C3.3 | C3.4 | C3.5 | C3.6 | C3.7 | C3.8 | C3.9 |
|---|---|---|---|---|---|---|---|---|
| 1 | 0 | 1 | 0 | 1 | 0 | 0 | MC, coded | 0 |
| 01 | 0 | 0 | 0 | 1 | 0 | 0 | No MC, coded | 0 |
| 001 | 0 | 1 | 0 | 0 | 0 | 0 | MC, not coded | 0 |
| 0001 1 | 0 | 0 | 0 | 0 | 1 | 0 | Intra | 0 |
| 0001 0 | 1 | 1 | 0 | 1 | 0 | 0 | MC, coded, quantized | 0 |
| 0000 1 | 1 | 0 | 0 | 1 | 0 | 0 | No MC. coded, quantized | 0 |
| 0000 01 | 1 | 0 | 0 | 0 | 1 | 0 | Intra, quantized | 0 |

wherein captions C3.1 to 3.9 are as follows:
C3.1 = macroblock_type VLC code
C3.2 = macroblock_quant
C3.3 = macroblock_motion_forward
C3.4 = macroblock_motion_backward
C3.5 = macroblock_pattern
C3.6 = macroblock_intra
C3.7 = spatial_temporal_weight_code_flag
C3.8 = Description (in words)
C3.9 = permitted spatial_temporal_weight_classes

TABLE 4

| C4.1 | C4.2 | C4.3 | C4.4 | C4.5 | C4.6 | C4.7 | C4.8 | C4.9 |
|---|---|---|---|---|---|---|---|---|
| 10 | 0 | 1 | 1 | 0 | 0 | 0 | Interpolated, not coded | 0 |
| 11 | 0 | 1 | 1 | 1 | 0 | 0 | Interpolated, coded | 0 |
| 010 | 0 | 0 | 1 | 0 | 0 | 0 | Backward, not coded | 0 |
| 011 | 0 | 0 | 1 | 1 | 0 | 0 | Backward, coded | 0 |
| 0010 | 0 | 1 | 0 | 0 | 0 | 0 | Forward, not coded | 0 |
| 0011 | 0 | 1 | 0 | 1 | 0 | 0 | Forward, coded | 0 |
| 0001 1 | 0 | 0 | 0 | 0 | 1 | 0 | Intra | 0 |
| 0001 0 | 1 | 1 | 1 | 1 | 0 | 0 | Interpolated, coded, quantized | 0 |
| 0000 11 | 1 | 1 | 0 | 1 | 0 | 0 | Forward, coded, quantized | 0 |
| 0000 10 | 1 | 0 | 1 | 1 | 0 | 0 | Backward, coded, quantized | 0 |
| 0000 01 | 1 | 0 | 0 | 0 | 1 | 0 | Intra, quantized | 0 |

wherein caption C4.1 to C4.9 have the following meanings:
C4.1 = macroblock_type VLC code
C4.2 = macroblock_quant
C4.3 = macroblock_motion_forward
C4.4 = macroblock_motion_backward
C4.5 = macroblock_pattern
C4.6 = macroblock_intra
C4.7 = spatial_temporal_weight_code_flag
C4.8 = Description (in words)
C4.9 = permitted spatial_temporal_weight_classes

Definitions for terms used in Tables 3 and 4 will now be provided. Macroblock_quant relates to a variable derived from the macroblock_type; it indicates whether or not the spatial_temporal_weight_code is present in a bitstream being processed in the decoder 50. Macroblock_motion_forward relates to a variable derived from macroblock_type according to Tables 3 and 4; this variable which functions as a flag affecting bitstream syntax and is used for decoding within the decoder 50. Macroblock_motion_backward relates to a variable derived from macroblock_type according to Tables 3 and 4; this variable which functions as a flag affects bitstream syntax and is used for decoding within the decoder 50. Macroblock_pattem is a flag derived from macroblock_type according to Tables 3, 4; it is set to 1 to a value 1 to indicate that coded_block_pattern() is present in a bitstream being processed. Macroblock_intra is a flag derived from macroblock_type according to tables 3, 4; this flag affects bitstream syntax and is used by decoding processes within the decoder 50.

Spatial_temporal_weight_code_flag is a flag derived from the macroblock_type; the flag is indicative of whether or not spatial_temporal_weight_code is present in the bitstream being processed in the decoder 50. The spatial_temporal_weight_code_flag is set to a value ‘0’to indicate that spatial_temporal_weight_code is not present in the bitstream, allowing the spatial_temporal_weight_class to be then derived. Conversely, the spatial_temporal_weight_code_flag is set to a value ‘1’ to indicate that spatial_temporal_weight_code is present in the bitstream, again allowing the spatial_temporal_weight_class to be derived. Spatial_temporal_weight_code is a two bit code which indicates, in the case of spatial scalability, how the spatial and temporal predictions are combined to provide a prediction for a given macroblock.

Frame_motion_type is a two-bit code indicating the macroblock prediction type. Thus, if frame_pred_frame_dct is equal to a value ‘1’, then frame_motion_type is omitted from the bitstream; in such a situation, motion vector decoding and prediction is performed as if frame motion type had indicated “frame_based prediction”. In a situation where intra macroblocks are present in a frame picture when concealment_motion_vectors are set to a value ‘1’, then frame_motion_type is not present in the bitstream; in this case, motion vector decoding and updating of the motion vector predictors is performed as if frame_motion_type had indicated “frame-based”. Table 5 elucidates further the meaning of frame_motion_type.

TABLE 5

| code | spatial_temporal_weight_class | prediction type | motion_vector_count | mv_format | dmv |
|---|---|---|---|---|---|
| 00 | | Reserved | | | |
| 01 | 0, 1 | Field-based | 2 | Field | 0 |
| 01 | 2, 3 | Field-based | 1 | Field | 0 |
| 10 | 0, 1, 2, 3 | Frame-based | 1 | Frame | 0 |
| 11 | 0, 2, 3 | Dual-prime | 1 | Field | 1 |

Field_motion_type is a two-bit code indicating the macroblock prediction type. In a case of intra macroblocks, for example in a field picture, when concealment_motion_vectors is equal to a value ‘1’, field_motion_type is not present in the bitstream to be decoded in the decoder 50; in such a situation, motion vector decoding and updating is executed as if field_motion_type had indicated “field-based”. Table 6 elucidates further the meaning of field_motion_type.

TABLE 6

| code | spatial_temporal_weight_class | prediction type | motion_vector_count | mv_format | dmv |
|---|---|---|---|---|---|
| 00 | | Reserved | | | |
| 01 | 0, 1 | Field-based | 1 | Field | 0 |
| 10 | 0, 1 | 16 × 8 MC | 2 | Field | 0 |
| 11 | 0 | Dual-prime | 1 | Field | 1 |

dct_type is a flag indicating whether or not a given macroblock is frame discrete cosine transform (DCT) coded or field DCT coded. If this flag is set to a value ‘1’, the macroblock is field DCT coded. In a situation that dct_type is not present in the bitstream to be processed, then the value of dct_type used in the remainder of decoding processes within the decoder 50 is derived from Table 7.

TABLE 7

| Condition | dct_type |
|---|---|
| picture_structure=“field” | Unused because there is no frame/ |
| | field distinction in a field picture |
| frame_pred_frame_dct=1 | 0 (“frame”) |
| !(macroblock_intra \|\| | Unused - macroblock is not coded |
| macroblock_pattern) | |
| macroblock is skipped | Unused - macroblock is not coded |

Thus, the decoder 50 is arranged to process macroblocks which can each have one or two motion vectors and is either field- or frame-based encoded. Consequently, a P-type macroblock is encodable according to the follow scheme:
(a) if a P-type picture is frame-based, then a macroblock can have one forward vector;
(b) if a P-type picture is field-based, then a macroblock can have one forward vector referring either to the top or bottom of a given field; and
(c) if a P-type picture is frame-based, then a macroblock can have two forward vectors, a first of the two vectors referring to the top of a given field, and a second of the two vectors referring to the bottom of a given field.

Moreover, a B-type macroblock is encodable according to the following schemes:
(a) if a B-type picture is frame-based, then a macroblock can have one of: one forward vector, one backward vector, backward and forward vectors, all as in frame prediction;
(b) if a B-type picture is frame-based, then a macroblock can have one of: two forward vectors, two backward vectors, four vectors (forward and backward), all as in field prediction with separate top and bottom fields; and
(c) if a B-type picture is field-based, then a macroblock can have one of: one forward vector, one backward vector, two vectors (forward and backward), all as in field prediction.

For motion vectors associated with macroblocks processed by the decoder 50, a variable motion_vector_count is derived from field_motion_type or frame_motion_type. Moreover, a variable mv_format is derived from field_motion_type or frame_motion_type and is used to indicate if a given motion vector is a field-motion vector or a frame-motion vector. Moreover, mv_forrnat is used in the syntax of the motion vectors and in processes of motion vector prediction dmv is derived from field_motion_type or frame_motion_type. Furthermore, motion_vertical_field-select[r][s] is a flag for indicating which reference field to use to form the prediction. If motion_vertical_field_select[r][s] has a value ‘0’, then a top reference field is used; conversely, if motion_vertical_field_select[r][s] has a value ‘1’, then a bottom reference field is used as provided in Table 9.

Table 8 provides a listing for an algorithm employed within the decoder 50 for handling motion vectors with parameter s.

TABLE 8

| motion_vectors(s) { | No. of bits | Mnemonic |
|---|---|---|
| if {motion_vector_count ==1) { | | |
| if{(mv_format == field) && (DMV != 1)) | | |
| motion_vertical_field_select[0][s] | 1 | uimsbf |
| motion_vector(0,s) | | |
| } else { | | |
| motion_vertical_field_select[1][s] | 1 | uimsbf |
| motion_vector(0,s) | | |
| motion_vertical_field_select[1][s] | 1 | uimsbf |
| motion_vector(1,s) | | |
| } | | |
| } | | |

Similarly, Table 9 provides a listing for an algorithm employed within the decoder 50 for handling motion vectors with parameters r, s.

TABLE 9

| motion_vectors(r,s) { | No. of bits | Mnemonic |
|---|---|---|
| motion_code[r][s][0] | 1-11 | vlclbf |
| if ((f_code[s][0] !=1) && | | |
| (motion_code[r][s][0] !=0)) | | |
| motion_residual[r][s][0] | 1-8 | uimsbf |
| if (dmv == 1) | | |
| dmvector[0] | 1-2 | vlclbf |
| motion_code[r][s][1] | 1-11 | vlclbf |
| if ((f_code[s][1] !=1) && | | |
| (motion_code[r][s][0] !=0)) | | |
| motion_residual[r][s][1] | 1-8 | uimsbf |
| motion_vector(1,s) | | |
| if (dmv == 1) | | |
| dmvector[1] | 1-2 | vlclbf |
| } | | |

In Tables 8, 9, motion_code[r][s][t] is a variable length code which is used in motion vector decoding in the decoder 50. Moreover, motion_residual[r][s][t] is an integer which is also used in motion vector decoding in the decoder 50. Furthermore, a number of bits in a bitstream for motion_residual[r][s][t], namely parameter r_size, is derived from f_code[s][t] as in Equation 3 (Eq. 3):
r_size=f_code[s][t]−1 Eq. 3

The number of bits for both motion_residual[0][s][t] and motion_residual[1][s][t] is denoted by f_code[s][t]. Additionally, dmvector[1] is a variable length code which is used in motion vector decoding within the decoder 50.

Although the embodiment of the decoder 50 is illustrated in FIG. 4 and elucidated by way of Equations 1 to 3 and Tables 1 to 9, other approaches to implementing the decoder 50 according to the invention are feasible. Thus, it will be appreciated that embodiments of the invention described in the foregoing are susceptible to being modified without departing from the scope of the invention, for example as defined by the accompanying claims.

Expressions such as “comprise”, “include”, “contain”, “incorporate”, “have”, “has”, “is”, “are” are intended to be construed non-exclusively, namely they do not preclude other unspecified parts or items also being present.

1. A method of decoding video data in a video decoder to regenerate a corresponding sequence of images, characterized in that the method includes the steps of:
(a) arranging for the decoder to include processing means coupled to an associated main data memory (and a data cache memory
(b) receiving the video data including anchor picture data in compressed form at the decoder and storing the data in the main memory
(c) processing the compressed video data in the processing means to generate corresponding macroblock data including motion vectors describing motional differences between the images in the sequence; and
(d) applying motion compensation in the processing means to generate from the macroblock data and one or more anchor pictures the corresponding sequence of decoded images;
the method being arranged to apply the motion compensation such that the motion vectors derived from the macroblocks used for reconstructing the sequence of images are analyzed and macroblocks accordingly sorted so as to provide for more efficient data transfer between the main memory and the processing means.

2. A method according to claim 1, wherein groups of macroblocks transferred between the processing means and the memory correspond to spatially neighboring macroblocks in one or more of the images.

3. A method according to claim 1, wherein the sequence of images includes at least one initial reference image from which subsequent images are generated by way of applying motion compensation using the motion vectors.

4. A method according to claim 3, wherein one or more of the images are represented in one or more corresponding video object planes in the memory, said one or more planes including data relating to at least one of coding contour information, motion information and textural information.

5. A method according to claim 4, wherein the video object planes are arranged to include one or more video objects which are mapped by said motion compensation in the processing means from one or more earlier images to one or more later images in the sequence.

6. A method according to claim 1, wherein the method in step (a) is arranged to receive video data read from a data carrier, preferably an optically readable and/or writable data carrier, and/or a data communication network.

7. A method according to claim 1, said method being arranged to be compatible with one or more block-based video compression schemes, for example MPEG standards.

8. A video decoder for decoding video data (ENC(VI)) to regenerate a corresponding sequence of images, characterized in that the decoder includes:
(a) receiving means for acquiring the video data (ENC(VI)) including anchor picture data in compressed form at the decoder and storing the data in the main memory;
(b) processing means for:
(i) processing the compressed video data to generate corresponding macroblock data including motion vectors describing motional differences between the images in the sequence; and
(ii) applying motion compensation using the motion vectors to generate from the macroblock data and one or more anchor pictures the corresponding sequence of decoded images;
the decoder being operable to apply the motion compensation such that the motion vectors derived from the macroblocks used for reconstructing the sequence of images are analyzed and macroblocks accordingly sorted so as to provide for more efficient data transfer between the main memory and the processing means.

9. A decoder according to claim 8, the decoder being arranged to process the sequence of images including at least one initial reference image from which subsequent images are generated by way of applying motion compensation using the motion vectors.

10. A decoder according to claim 9, wherein one or more of the images are represented in one or more corresponding video object planes in the memory, said one or more planes including data relating to at least one of coding contour information, motion information and textural information.
